(19) United States
(12) Patent Application Publication
(10) Pub. No.: US 2026/0331916 A1
(43) Pub. Date: Oct. 22, 2026

(54) METHOD AND DEVICE FOR CONTROLLING RAPID AGGREGATION OF MASSIVE FLEXIBLE LOADS

(71) Applicant: TSINGHUA UNIVERSITY, Beijing (CN)

(72) Inventors: Guangchun RUAN, Beijing (CN); Haiwang ZHONG, Beijing (CN); Yiliu HE, Beijing (CN); Qing XIA, Beijing (CN); Chongqing KANG, Beijing (CN)

(21) Appl. No.: 19/112,158

(22) PCT Filed: Sep. 15, 2023
(86) PCT No.: PCT/CN2023/119004

§ 371 Date: Mar. 14, 2025

(30) Foreign Application Priority Data
Sep. 15, 2022 (CN) 202211121197.5

(51) Int. Cl. H02J 3/175; G05B 13/04; H02J 103/30

(52) U.S. Cl. CPC H02J 3/175; G05B 13/042; H02J 2103/30

(57) ABSTRACT

A method for controlling rapid aggregation of massive flexible loads includes: obtaining features of flexible loads in a power system; generating a flexible load feature vector according to the features of the flexible loads, and obtaining a flexible load cluster by performing hierarchical clustering on the flexible loads based on the flexible load feature vector; constructing a flexible load control model based on the flexible load cluster, and obtaining a data-driven fitting function of the control model according to historical control signals of the flexible loads; and constructing a centralized rapid aggregation control model of the flexible loads based on the data-driven fitting function, formulating a flexible load control solution using the centralized rapid aggregation control model, and obtaining an optimal aggregation control strategy of the flexible loads via the flexible load control solution.

### CROSS-REFERENCE TO RELATED APPLICATIONS

This application is a U.S. national phase entry under 35 U.S.C. § 371 of International Application No. PCT/CN2023/119004, filed on Sep. 15, 2023, which claims priority to Chinese Patent Application No. 202211121197.5, filed on Sep. 15, 2022, the entire disclosures of which are hereby incorporated herein by reference.

### TECHNICAL FIELD

The present disclosure relates to a technical field of power demand response, and specifically to a method and a device for controlling rapid aggregation of massive flexible loads, and a storage medium.

### BACKGROUND

At present, China has put forward an important goal of constructing “a new power system with new energy as the main body”. Reliable consumption of an extremely high proportion of the renewable energy relies on flexibility resources, but such resource reserves are becoming increasingly tight, and there is an urgent need to develop demand-side resources that are not fully activated. Flexible loads are an important part of the demand-side resources that are not fully activated, including an electric vehicle, a smart building, a multi-energy microgrid, and so on. However, it is still difficult for related art to efficiently aggregate and control massive heterogeneous flexible load resources, which has become a key bottleneck in improving the flexible regulation ability of the new power system.

The existing flexible load aggregation control technologies can be divided into two categories: centralized and distributed aggregation control technologies. The centralized aggregation control technology means that a control center collects all details of flexible load operation models first, and then builds a large-scale refined centralized model to realize control of various flexible load resources. A prominent problem with this category of technology is a privacy leakage issue, that is, the control center is not an owner of the flexible loads, and flexible load users are often reluctant to provide their complete operational model details. Moreover, the centralized model established by this category of technology is usually very complex and has a very large scale, the computational complexity is very high, and the solving speed is often unable to meet practical needs. The distributed aggregation control technology refers to that an iterative method is used between the control center and the flexible load users iteratively, to adjust the control scheme until reaching an optimal system state. A prominent problem of this category of technology is that convergence efficiency is difficult to be guaranteed. Specifically, frequent communication between the control center and the flexible load users inevitably and significantly increases a communication pressure, and multiple rounds of iteration usually lead to a low convergence rate. This category of technology is obviously different from the existing centralized service form, and thus it is seriously restricted in the practical engineering application.

In addition, it should be noted that most of current flexible load aggregation control models are expressed purely analytically. These modeling expression forms often have many redundant expressions, which may affect computational efficiency. In addition, it is difficult to embed historical experience in these modeling forms, which limits further improvement of model characterization accuracy. In contrast, a data-driven method may eliminate the redundant expressions by effectively combining the historical experience, and effectively improve representation ability and computational efficiency of an analytic aggregation control model. However, relevant researches and application are still in a preliminary exploration stage.

### SUMMARY

According to a first aspect of the embodiments of the present disclosure, a method for controlling rapid aggregation of massive flexible loads is provided. The method includes:
obtaining features of flexible loads in a power system;
generating a flexible load feature vector according to the features of the flexible loads, and obtaining a flexible load cluster by performing hierarchical clustering on the flexible loads based on the flexible load feature vector;
constructing a flexible load control model based on the flexible load cluster, and obtaining a data-driven fitting function of the control model according to historical control signals of the flexible loads; and
constructing a centralized rapid aggregation control model of the flexible loads based on the data-driven fitting function, formulating a flexible load control solution using the centralized rapid aggregation control model, and obtaining an optimal aggregation control strategy of the flexible loads via the flexible load control solution.

According to a second aspect of the embodiments of the present disclosure, a device for controlling rapid aggregation of massive flexible loads is provided. The device includes:
a processor;
a memory for storing instructions executable by the processor,
in which the processor is configured to:
obtain features of flexible loads in a power system;
generate a flexible load feature vector according to the features of the flexible loads, and obtain a flexible load cluster by performing hierarchical clustering on the flexible loads based on the flexible load feature vector;
construct a flexible load control model based on the flexible load cluster, and obtain a data-driven fitting function of the control model according to historical control signals of the flexible loads; and
construct a centralized rapid aggregation control model of the flexible loads based on the data-driven fitting function, formulate a flexible load control solution using the centralized rapid aggregation control model, and obtain an optimal aggregation control strategy of the flexible loads via the flexible load control solution.

According to a third aspect of the embodiments of the present disclosure, a non-transitory computer-readable storage medium is provided. The storage medium stores instructions that, when executed by a processor of an electronic device, cause the electronic device to perform a method for controlling rapid aggregation of massive flexible loads, the method including:
obtaining features of flexible loads in a power system;
generating a flexible load feature vector according to the features of the flexible loads, and obtaining a flexible load cluster by performing hierarchical clustering on the flexible loads based on the flexible load feature vector;
constructing a flexible load control model based on the flexible load cluster, and obtaining a data-driven fitting function of the control model according to historical control signals of the flexible loads; and
constructing a centralized rapid aggregation control model of the flexible loads based on the data-driven fitting function, formulating a flexible load control solution using the centralized rapid aggregation control model, and obtaining an optimal aggregation control strategy of the flexible loads via the flexible load control solution.

Additional aspects and advantages of embodiments of present disclosure may be given in part in the following descriptions, become apparent in part from the following descriptions, or be learned from the practice of the embodiments of the present disclosure.

### BRIEF DESCRIPTION OF THE DRAWINGS

The above and/or other aspects and advantages of embodiments of the present disclosure will become apparent and more readily appreciated from the following descriptions made with reference to the accompanying drawings.

FIG. 1 is a flowchart of a method for controlling rapid aggregation of massive flexible loads according to an embodiment of the present disclosure.

FIG. 2 is a three-dimensional diagram of a typical flexible load cluster control model according to an embodiment of the present disclosure.

FIG. 3 is a schematic structure diagram of an apparatus for controlling rapid aggregation of massive flexible loads according to an embodiment of the present disclosure.

FIG. 4 is a schematic structure diagram of a model constructing module according to an embodiment of the present disclosure.

FIG. 5 is a schematic structure diagram of a model constructing module according to an embodiment of the present disclosure.

FIG. 6 is a schematic structure diagram of an aggregation control module according to an embodiment of the present disclosure.

### DETAILED DESCRIPTION

It needs to be noted that embodiments in the present disclosure and features in the embodiments may be combined with each other, provided that there is no conflict between them. The present disclosure is described in detail below with reference to accompanying drawings and embodiments.

In order to enable those skilled in the art to understand the technical solutions of the present disclosure, reference will be made clearly and completely technical solutions in the embodiments of the present disclosure with accompanying drawings. Obviously, the embodiments described here are only part of the embodiments of the present disclosure and are not all embodiments of the present disclosure. Based on the embodiments of the present disclosure, other embodiments obtained by those skilled in the art without creative labor are within scope of the present disclosure.

The method and apparatus for controlling rapid aggregation of massive flexible loads in the embodiments of the present disclosure are described below with reference to the accompanying drawings.

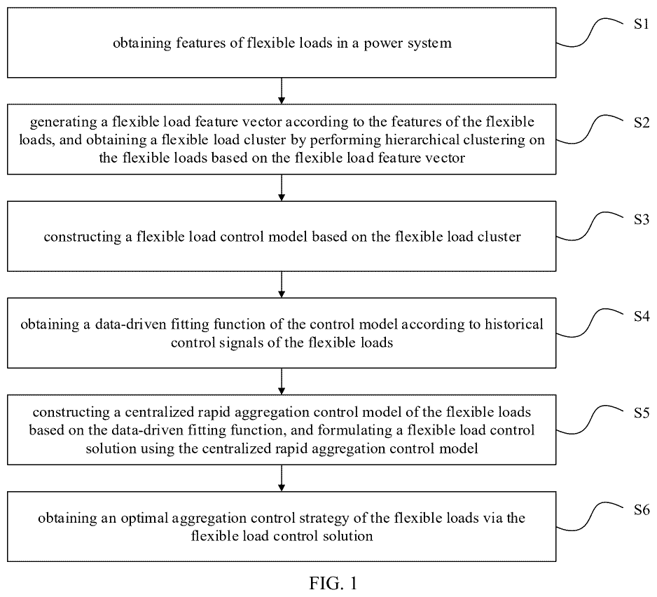

FIG. 1 is a flowchart of a method for controlling rapid aggregation of massive flexible loads according to an embodiment of the present disclosure.

It is understandable that FIG. 1 shows an overall flowchart of the present disclosure, including two main stages: a first stage is auto-reporting a control model by a flexible load cluster, and a second stage is formulating a flexible load control solution by a control center. The control center refers to a load service provider, a load aggregator, a distribution network dispatching center, a microgrid control center, and others.

The two-stage process in the method is different from a traditional centralized or distributed process. The overall two-stage process may include: step 1 of carrying out an initial configuration and obtaining feature data of flexible loads, step 2 of carrying out hierarchical clustering of the flexible loads, step 3 of generating a control model for a flexible load cluster, step 4 of generating a data-driven fitting function of the control model, step 5 of calculating a centralized rapid aggregation control solution of massive flexible loads, and step 6 of obtaining an optimal aggregation control strategy by organizing and outputting a result. By implementing the two-stage process of the method, the aggregation control can be accomplished with only one information exchange, in which information obtained via an aggregation equivalence also helps to avoid privacy disclosure.

Specifically, stage 1 includes steps 2 to 4, and stage 2 includes step 5. Detailed steps shown in FIG. 1 are explained further below.

As shown in FIG. 1, this method includes but is not limited to the following steps.

At S1, basic data and parameters are obtained, and feature data of flexible loads is obtained.

It may be understood that an initial configuration is required before obtaining the feature data of the flexible loads in a power system.

In some embodiments, a state of a communication network is checked. Whether a communication channel between a control center and a flexible load is smooth is checked. In case of a communication failure, it needs to suspend an abnormal state of the communication line and arrange maintenance as soon as possible. At the same time, the disconnected load resource may not be able to participate in subsequent aggregation optimization and control.

In some embodiments, incentive electricity price data is read. The incentive electricity price here refers to an electricity price condition in a specific scheduling scenario, which may be compatible with various electricity price mechanisms such as a peak and valley electricity price, a time-of-use electricity price, a real-time electricity price, etc., and may also be selected as probability prediction data of the electricity price according to needs. Subsequently, a specific aggregation control solution may be developed based on the incentive electricity price.

In some embodiments, various parameter values and format requirements of the aggregation control are read. The parameters include a maximum allowed number of load clusters, a maximum allowed number of control model segments, system operating boundary parameters (such as a number of periods, and a total capacity limit of the system), an optimization algorithm parameter, and so on. The format requirements mainly include a communication channel and a check rule, a control signal standardization coding mode, and so on.

After the initial configuration, the feature data of the flexible loads in the power system is obtained, mainly in two ways: reporting directly by a user and a statistical analysis of historical data. After obtaining the features, subsequent control aggregation steps may be proceed.

At S2, a flexible load feature vector is obtained according to the features of the flexible loads, and a flexible load cluster is obtained by performing hierarchical clustering on the flexible loads based on the flexible load feature vector.

In particular, the flexible load feature vector is generated and normalized. The flexible load has many typical features, including a load type (industrial/commercial/residential), a voltage level of load electricity consumption, monthly average power consumption of the load, a load time-series feature (time-shiftable/non-time-shiftable), a load fluctuation feature, a load control variable, and so on. These typical feature indexes of the flexible load are represented by γᵢ in turn, and the feature vector is obtained by splicing these feature variables.

In order to reduce an adverse impact of a variable dimension difference, it is necessary to carry out normalization processing, including maximum-minimum normalization, zero mean normalization and so on. In some embodiments, a formula for the maximum-minimum normalization is expressed as:

$${γ}_{i} = \frac{{γ}_{i} - {γ}_{i , m i n}}{{γ}_{i , ma x} - {γ}_{i , m i n}} , ∀ i$$

where γ_{i,max} represents a maximum value of a feature index γᵢ, and γ_{i,min} represents a minimum value of the feature index γᵢ.

Further, the hierarchical clustering of the flexible loads based on a similarity is performed. The hierarchy refers to differentiate different loads according to a load control variable, such as an electricity price incentive load, a temperature control load, a short-time response dispatching command load and so on. A purpose of the hierarchy is to ensure that all loads in a layer are unified to be same in terms of control, so that a unified signal can be used to control the entire flexible load cluster.

In a same layer, flexible loads may be more finely clustered and divided according to a similarity rule, thus obtaining more refined control units, but corresponding computational complexity is also increased. It is necessary to make a proper trade-off between accuracy controlling and complexity controlling in the practical engineering application. The similarity rule is generally measured by a distance function, and is expressed as:

sᵢⱼ=DIST(γᵢ,γⱼ),∀i,∀j

In the formula, sᵢⱼ represents a distance between an index γᵢ and γⱼ, and DIST(⋅) represents a distance function. Common distance functions include a Euclidean distance function, a Manhattan distance function, a Hamming distance function, a cosine similarity function, and so on.

Finally, a clustering process is carried out based on the sᵢⱼ index, and a typical clustering purpose is to maximize a clustering degree of the cluster (a difference within a group is as small as possible, and a difference between groups is as large as possible). Clustering methods include a K-means method, a K-median method, a density-based spatial clustering of applications with noise (DBSCAN) method, a hierarchical clustering method, and so on. By combining all steps mentioned above, a hierarchical clustering result of the flexible loads can be obtained. In fact, each divided cluster is a group of flexible loads with similar features.

At S3, a flexible load control model is constructed based on the flexible load cluster.

In particular, a flexible load operation model is reconstructed and a control variable is determined. The flexible load operation model refers to an internal model for determining a power consumption plan, which is usually known only to the user of the load, and is generally regarded as user privacy because it often involves a key behavioral parameter or preference information of the user. A typical flexible load operating model is expressed as:

min c^{T}p

s.t. A₁p=b₁

A₂p≤b₂

where a decision variable is flexible load power consumption p, while remaining variables c, A₁, A₂, b₁ and b₂ are all model parameters. The model is a linear programming model with an equality constraint and an inequality constraint, and has good universality. It is mainly pointed out that the linear programming model, due to its concise form and high solving efficiency, is used frequently in the engineering application, and in fact, many models with more complex forms may be approximately represented, in some parts, by the linear programming model.

It may be understood that reconstructing the flexible load operation model means to reorganize the model from a perspective of function input and output, and is specifically divided into a control variable, an environmental state, response power consumption and an auxiliary variable.

Further, the control variable and the environmental state are inputs for the running model, while the auxiliary variable and the response power consumption are optimal solution of the model. The control variable refers to a variable that may be directly controlled or adjusted. The control variable varies in different application scenarios, and the control variable has a strict correspondence relationship with a control mode of preceding steps. The environmental state is generally an input parameter of the flexible load operation model, and this variable usually cannot be controlled manually, but it is only regarded as a boundary condition of the optimization model. The response power consumption is an optimal power consumption plan obtained by a flexible aggregation optimization decision. The “response” used here means that, an optimal power consumption level may be adjusted accordingly for different control variable settings and environmental states, due to a correspondence relationship therebetween. The auxiliary variable refers to a variable other than the response power consumption in the optimal solution. Some auxiliary variables are often introduced in modeling of an operating model so as to assist in constructing the operation model.

An air conditioning load (a temperature-controlled load) is taken as an example for exemplary description. A control variable of the air conditioning load is a predefined temperature value, the environment state includes a current indoor temperature and an air conditioning operating boundary parameter, the response power consumption is power consumption of an air conditioner, and the auxiliary variable may be an auxiliary variable of a utility function.

Furthermore, a standardized closed-form solution, that is programmed based on multiple parameters, is constructed. As the above steps define the control variable and the response power consumption in the flexible load operation model, a mapping relationship between them may be further established here. The mapping relationship is called a flexible load control model. In a general application, in order to avoid solving the optimization model repeatedly, the standardized closed-form solution of the control model may be obtained by combining a parametric programming theory.

In the embodiments of the present disclosure, the control variable mainly appears in a constraint condition or an objective function of the operating model, which is classified and discussed below.

Case 1: when the control variable appears in the constraint condition, perturbation coefficient matrixes H₁ and H₂ are introduced, the control variable is represented by x, and then the flexible load operation model is transformed into:

min c^{T}p

s.t. A₁p=b₁−H₁x

A₂p≤b₂−H₂x

Here, A₂ is divided into two parts: A₂=[Ã₂, Ā₂], in which the Ã₂ corresponds to an active constraint (equivalent to equating) of an inequality constraint, and Ā₂ corresponds to an inactive constraint. A splitting method may be applied to b₂ and H₂ in a totally same way. By introducing a new notation: Ã=[A₁, Ã₂], \tilde{b} and \tilde{H} may be obtained in a similar way.

A critical region of the control variables x is defined as: Ω={x|(H̅−ĀÃ⁻¹\tilde{H})x<b̅−ĀÃ⁻¹\tilde{b}}. According to the multi-parametric programming theory, an optimal solution p on the critical region may be directly obtained by the control variable x, and the closed-form solution is also called a value function. A specific expression is as follows.

p=Ã⁻¹(\tilde{b}−\tilde{H}x),x∈Ω

The above equation is called a standardized closed-form solution of the flexible load control model, which is expressed in a piecewise linearization form.

Case 2: when the control variable appears in the objective function, a perturbation coefficient H is introduced, and the flexible load operation model is transformed into:

min(c^{T}−x^{T}H)p

s.t. A₁p=b₁

A₂p≤b₂

According to the multi-parametric programming theory, the closed-form solution of the control model is as follows.

p=Ã⁻¹\tilde{b},x∈Ω={x|−Ã^{-T}H^{T}x<Ã^{-T}c}

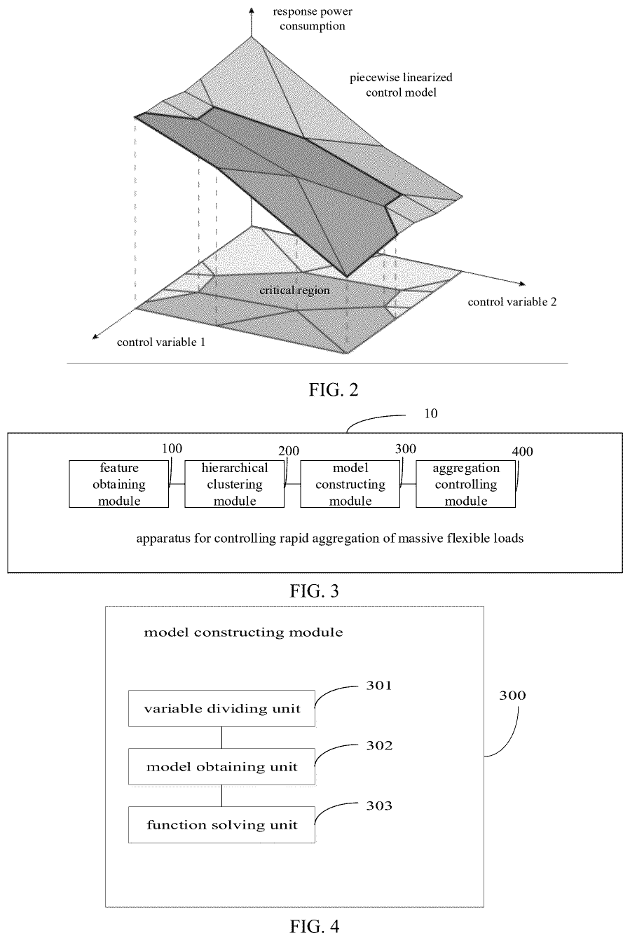

FIG. 2 is a three-dimensional diagram of a typical flexible load cluster control model according to the embodiments of the present disclosure. Two control variables are input into the model, and the response power consumption are output from the model. An input-output mapping relationship is given in the piecewise linearization form. When values of two control variables fall in a certain critical region, the response power consumption may be calculated and solved using the corresponding value function.

Further, for all flexible load clusters obtained in above steps, it needs to generate respective standardized closed-form solutions of their control models in turn. The closed-form solutions may be directly uploaded to the control center, or further simplified by a subsequent data-driven fitting method, which effectively reduces a number of critical region division, and reduces computational complexity and improves overall computational efficiency.

At S4, a data-driven fitting function of the control model is obtained according to historical control signals of the flexible loads.

In particular, a Monte Carlo sampling method is used to generate a historical control signal dataset. The data here specifically refers to control signal data, which is a basic condition for performing fitting processing. Generally, the dataset may be constructed by historical data accumulation or simulation calculation. However, due to a limited amount of historical data, it is usually necessary to first use the historical data to fit an experience curve, then use the Monte Carlo sampling method to generate the simulation data based on the experience curve, and finally combine the data to form a larger dataset.

Further, probability density-based data-driven fitting processing is performed. First, it is first determined which critical region the control signal data respectively obtained from the historical experience control signal dataset fall into. Data points falling on a boundary between two critical regions may be assigned to any one of the regions. The number of data points in each critical region is then counted to obtain probability densities of these critical regions being called. Specifically, a probability ωᵢ that the critical region Ωᵢ is called is expressed as:

$${ω}_{i} = \frac{{N}_{{Ω}_{i}}}{N} \times 100 \%$$

where N_{Ω}_{ᵢ} represents the number of data points in a critical region, and N represents a total amount of data.

Further, a density boundary threshold ωₜₕ is introduced. For a critical region ωᵢ≥ωₜₕ, a complete expression of the critical region may be directly preserved. For critical regions ωᵢ<ωₜₕ, the corresponding critical regions is rarely called, and these regions may be merged directly to form a new critical region, or these regions may be grouped and merged into a smaller number of new critical regions. After the processing of the density boundary threshold is introduced, the number of regions can be effectively reduced, which helps to improve computational efficiency of subsequent centralized optimization.

In some embodiments, a method for generating the new critical region is introduced. The new critical region is an approximate equivalent for the group of the original critical regions. First, union processing is performed on the original critical regions, and then an approximate value function is obtained by a multiple linear regression.

Further, the data-driven fitting control model is integrated and packaged. The retained critical regions and new generated critical regions are combined to form the data-driven fitting control model, which may be uploaded by the respective flexible load cluster to the control center.

It can be understood that in order to maintain a uniform communication format, communication information is expressed as [R, αᵣ, βᵣ, Qᵣ, qᵣ]. R represents a total number of critical regions, αᵣ, βᵣ represent a primary term and a constant term of the value function, Qᵣ, qᵣ represent a primary term and a constant term of the critical region expression. In transmission, a split signal is transmitted between each two quantities. Data of r=1 is transmitted first, and then r=2 is transmitted until r=R is transmitted. It can be known that above communication information does not directly expose a user-sensitive operating parameter, but the information may effectively support execution of centralized scheduling, and does not need repeated iteration to update the report information.

At S5, a centralized rapid aggregation control model of the flexible loads is constructed based on the data-driven fitting function, and a flexible load control solution is formulated using the centralized rapid aggregation control model.

Specifically, the control model is transformed into a constraint equation of a mixed integer linear form. After receiving control models reported by respective flexible load clusters, the control center needs to convert these models into the constraint equations, and then embed them into the centralized optimization model for further use.

As an example, it is necessary to introduce a series of 0/1 variables to complete conversion. A constraint expression is as follows.

$${P}_{i t} = {\sum }_{r} {p}_{irt} , ∀ i , ∀ t$$

$$0 \leq {p}_{i r t} \leq M {π}_{i r} , ∀ i , ∀ r , ∀ t$$

$${\sum }_{r} {π}_{i r} = 1 , ∀ i$$

$${p}_{irt} = {α}_{ir} {x}_{irt} + {β}_{ir} + {ε}_{irt}^{+} - {ε}_{irt}^{-} , ∀ i , ∀ r , ∀ t$$

$${Q}_{i r} {x}_{i r t} = {q}_{i r} + {δ}_{i r t}^{+} - {δ}_{irt}^{-} , ∀ i , ∀ r , ∀ t$$

$$0 \leq {ε}_{irt}^{+} , {ε}_{irt}^{-} , {δ}_{i r t}^{+} \leq M ( 1 - {π}_{i r} ) , ∀ i , ∀ r , ∀ t$$

$$0 \leq {δ}_{i r t}^{-} \leq M {π}_{ir} , ∀ i , ∀ r , ∀ t$$

where Pᵢₜ represents power consumption of a flexible load cluster i at a time t, and pᵢᵣₜ represents a series of modeling auxiliary variables, and its sum represents total power consumption, in which each pᵢᵣₜ corresponds to a critical region, πᵢᵣ represents a newly introduced 0/1 integer variable, πᵢᵣ=1 indicates that an r-th critical region of a flexible load cluster i is activated, a corresponding pᵢᵣₜ may be calculated according to the value function, and αᵢᵣ, βᵢᵣ are from information reported by the cluster i. In addition, it is defined that only one critical region is activated, and an activated critical region and a slack variable also need to meet a constraint condition, in which the constraint condition refers to

$${ε}_{irt}^{+} , {ε}_{irt}^{-} , {δ}_{irt}^{+} , {δ}_{irt}^{-} .$$

It may be understood that the above constraint equation set is actually a formulaic description of a piecewise linear function similar to that in FIG. 2.

Further, the centralized rapid aggregation control model is constructed. The rapid aggregation control model refers to a mathematical programming model that coordinates and designs various control signals to realize aggregation control of massive heterogeneous flexible loads. The model not only includes control logics of respective flexible load clusters, but also includes an overall objective function and a system-level constraint condition, which are introduced below.

The overall objective function may be set to maximize social utility, and a typical objective function expression is as follows.

$$min {c}_{2} {P}_{t}^{2} + {c}_{1} {P}_{t} + {c}_{0}$$

where Pₜ=ΣᵢPᵢₜ represents total power consumption of all flexible loads, which is obtained from a sum of power consumption of respective flexible load clusters.

The above objective function adopts a utility expression of a quadratic function, which usually sets c₂<0, c₁>0, to satisfy a diminishing marginal utility rule. Sometimes, for a sake of simplification, it is also possible to omit the quadratic term to obtain an expression of a linear utility function.

There are many kinds of system-level constraint conditions, which often have great differences. Two classical system constraints are an upper and lower bound constraint and a minimum daily total power consumption constraint. The expression is as follows.

P≤Pₜ≤P̅,∀t

ΣₜPₜ≥E

where P, P̅ represent the upper bound and the lower bound of the power consumption respectively, and E represents the minimum daily total power consumption.

Further, the centralized rapid aggregation control model is solved. The rapid aggregation control model constructed is essentially a mixed integer linear programming model, which may be solved by a branch and bound method, a tangent plane method and other classical optimization algorithms, and may be directly processed by a mature optimization software package in practical engineering. According to a requirement of running time, termination upon reaching a solution time upper bound and appropriately relaxing a dual bound may be further adopted to avoid excessively long solution time.

At S6, an optimal aggregation control strategy of the flexible loads is obtained via the flexible load control solution.

Specifically, an optimization result of an optimization solution of S5 is organized. Each optimal control signal is processed according to a standardized coding mode read in the above steps, and then is sent to the corresponding flexible load cluster. Then the flexible cluster makes a local decision and obtains corresponding optimal power consumption. If the control center detects a small excess of total power consumption (due to an approximate fitting error), a small reduction is distributed proportionally to respective flexible load clusters.

All steps may generate a running log during the execution process. The step may comprehensively organize all kinds of results and log records in the above calculation process, and then store them in a backup database according to a regulation for further verification.

At this point, the whole process for controlling the rapid aggregation of the massive flexible loads is completed.

According to the method for controlling rapid aggregation of massive flexible loads in the embodiments of the present disclosure, the data-driven method is fully used to improve the computational efficiency of aggregation control, which may effectively solve the conflict between the privacy protection and the computational efficiency, and realize the efficient integration and the centralized control of the massive heterogeneous flexible load resources.

In order to realize the above embodiments, as shown in FIG. 3, the embodiments of the present disclosure also provide an apparatus 10 for controlling rapid aggregation of massive flexible loads. The apparatus 10 includes a feature obtaining module 100, a hierarchical clustering module 200, a model constructing module 300, and an aggregation controlling module 400.

The feature obtaining module 100 is configured to obtain basic data and parameters, and obtain feature data of flexible loads.

The hierarchical clustering module 200 is configured to obtain a flexible load feature vector according to features of the flexible loads, and obtain a flexible load cluster by performing hierarchical clustering on the flexible loads based on the flexible load feature vector.

The model constructing module 300 is configured to construct a flexible load control model based on the flexible load cluster, and obtain a data-driven fitting function of the control model according to historical control signals of the flexible loads.

The aggregation controlling module 400 is configured to construct a centralized rapid aggregation control model of the flexible loads based on the data-driven fitting function, formulate a flexible load control solution using the centralized rapid aggregation control model, and obtain an optimal aggregation control strategy of the flexible loads via the flexible load control solution.

Further, the hierarchical clustering module 200 is further configured to:
obtain the flexible load feature vector by splicing the features of the flexible loads via a normalization method; and
obtain a hierarchical clustering result of the massive flexible loads by performing the hierarchical clustering on the massive flexible loads via a predefined clustering method based on the flexible load feature vector and a similarity rule, in which the hierarchical clustering result includes different flexible load clusters.

Further, as shown in FIG. 4, the model constructing module 300 includes:
a variable dividing unit 301, configured to obtain a flexible load operation model, and obtain a control variable, an environment variable, response power consumption, and an auxiliary variable of the flexible load cluster from the flexible load operation model;
a model obtaining unit 302, configured to obtain the flexible load control model based on a relationship among the control variable, the environment variable, the response power consumption, and the auxiliary variable; and
a function solving unit 303, configured to construct a standardized closed-form solution of the flexible load control model based on the control variable and the flexible load operation model.

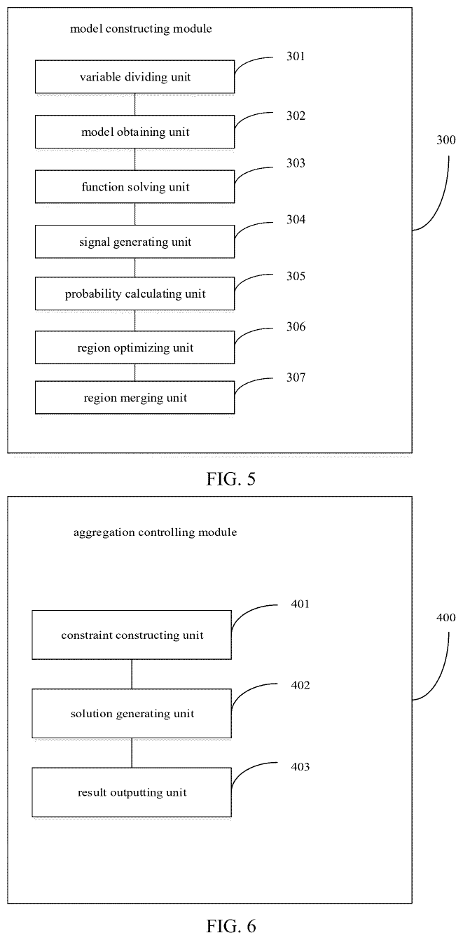

Further, as shown in FIG. 5, the model constructing module 300 further includes:
a signal generating unit 304, configured to generate a historical control signal dataset of the flexible loads using a Monte Carlo sampling method;
a probability calculating unit 305, configured to determine whether control signals in the historical control signal dataset falls within critical regions, count a number of control signals in each critical region according to the determined result, and obtain probability densities that the critical regions being called;
a region optimizing unit 306, configured to compare the probability densities that the critical regions being called with a density boundary threshold, and obtain a critical region optimization result by optimizing the critical regions according to the comparison result, in which the critical region optimization result includes retained critical regions and new generated critical regions; and
a region merging unit 307, configured to obtain a data-driven fitting control model by merging the retained critical regions with the new generated critical regions.

Further, as shown in FIG. 6, the aggregation controlling module includes:
a constraint constructing unit 401, configured to obtain a mixed-integer linear constraint equation according to the data-driven fitting control model, and construct the centralized rapid aggregation control model based on constraint equation expression;
a solution generating unit 402, configured to obtain an optimal solution of a flexible load control signal by solving the centralized rapid aggregation control model using a predefined optimization algorithm; and
a result outputting unit 403, configured to obtain an optimal control signal based on the optimal solution of the flexible load control signal, and obtain corresponding optimal power consumption based on the optimal control signal and the flexible load cluster.

According to an apparatus for controlling rapid aggregation of massive flexible loads in the embodiments of the present disclosure, the data-driven method is fully used to improve the computational efficiency of aggregation control, which can effectively solve the conflict between the privacy protection and the computational efficiency, and realize the efficient integration and centralized control of the massive heterogeneous flexible load resources.

In addition, terms such as “first” and “second” are used herein for purposes of description and are not intended to indicate or imply relative importance or significance. Thus, the feature defined with “first” and “second” may include one or more this feature. In the description of the present disclosure, “a plurality of” means at least two, for example, two or three, unless specified otherwise.

Reference throughout this specification to “an embodiment,” “some embodiments,” “an example,” “a specific example,” or “some examples,” means that a particular feature, structure, material, or feature described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or features may be combined in any suitable manner in one or more embodiments or examples. In addition, different embodiments or examples and features of different embodiments or examples described in the specification may be combined by those skilled in the art without mutual contradiction.

Although embodiments of the present disclosure have been shown and described above, it may be understood that above embodiments are just explanatory, and cannot be construed to limit the present disclosure, for those skilled in the art, changes, alternatives, and modifications may be made to the embodiments without departing from spirit, principles and scope of the present disclosure.

1. A method for controlling rapid aggregation of massive flexible loads, comprising:
obtaining features of flexible loads in a power system;
generating a flexible load feature vector according to the features of the flexible loads, and obtaining a flexible load cluster by performing hierarchical clustering on the flexible loads based on the flexible load feature vector;
constructing a flexible load control model based on the flexible load cluster, and obtaining a data-driven fitting function of the control model according to historical control signals of the flexible loads; and
constructing a centralized rapid aggregation control model of the flexible loads based on the data-driven fitting function, formulating a flexible load control solution using the centralized rapid aggregation control model, and obtaining an optimal aggregation control strategy of the flexible loads via the flexible load control solution.

2. The method of claim 1, wherein obtaining the flexible load feature vector according to the features of the flexible loads, and obtaining the flexible load cluster by performing the hierarchical clustering on the flexible loads based on the flexible load feature vector, comprising:
obtaining the flexible load feature vector by splicing the features of the flexible loads via a normalization method; and
obtaining a hierarchical clustering result of the massive flexible loads by performing the hierarchical clustering on the massive flexible loads via a predefined clustering method based on the flexible load feature vector and a similarity rule, wherein the hierarchical clustering result comprises different flexible load clusters.

3. The method of claim 1, wherein constructing the flexible load control model based on the flexible load cluster comprises:
obtaining a flexible load operation model, and obtaining a control variable, an environment variable, response power consumption, and an auxiliary variable of the flexible load cluster from the flexible load operation model;
obtaining the flexible load control model based on a relationship among the control variable, the environment variable, the response power consumption, and the auxiliary variable; and
constructing a standardized closed-form solution of the flexible load control model based on the control variable and the flexible load operation model.

4. The method of claim 1, wherein obtaining the data-driven fitting function of the control model according to the historical control signals of the flexible loads comprises:
generating a historical control signal dataset of the flexible loads using a Monte Carlo sampling method;
determining whether control signals in the historical control signal dataset falls within critical regions, counting a number of control signals in each critical region according to the determined result, and obtaining probability densities that the critical regions being called;
comparing the probability densities that the critical regions being called with a density boundary threshold, and obtaining a critical region optimization result by optimizing the critical regions according to the comparison result, wherein the critical region optimization result comprises retained critical regions and new generated critical regions; and
obtaining a data-driven fitting control model by merging the retained critical regions with the new generated critical regions.

5. The method of claim 4, wherein formulating the flexible load control solution using the centralized rapid aggregation control model, and obtaining the optimal aggregation control strategy of the flexible loads via the flexible load control solution comprises:
obtaining a mixed-integer linear constraint equation according to the data-driven fitting control model, and constructing the centralized rapid aggregation control model based on constraint equation expression;
obtaining an optimal solution of a flexible load control signal by solving the centralized rapid aggregation control model using a predefined optimization algorithm; and
obtaining an optimal control signal based on the optimal solution of the flexible load control signal, and obtaining corresponding optimal power consumption based on the optimal control signal and the flexible load cluster.

6.-10. (canceled)

11. A device for controlling rapid aggregation of massive flexible loads, comprising:
a processor;
a memory for storing instructions executable by the processor,
wherein the processor is configured to:
obtain features of flexible loads in a power system;
generate a flexible load feature vector according to the features of the flexible loads, and obtain a flexible load cluster by performing hierarchical clustering on the flexible loads based on the flexible load feature vector;
construct a flexible load control model based on the flexible load cluster, and obtain a data-driven fitting function of the control model according to historical control signals of the flexible loads; and
construct a centralized rapid aggregation control model of the flexible loads based on the data-driven fitting function, formulate a flexible load control solution using the centralized rapid aggregation control model, and obtain an optimal aggregation control strategy of the flexible loads via the flexible load control solution.

12. A non-transitory computer-readable storage medium storing instructions that, when executed by a processor of an electronic device, cause the electronic device to perform a method for controlling rapid aggregation of massive flexible loads, the method comprising:
obtaining features of flexible loads in a power system;
generating a flexible load feature vector according to the features of the flexible loads, and obtaining a flexible load cluster by performing hierarchical clustering on the flexible loads based on the flexible load feature vector;
constructing a flexible load control model based on the flexible load cluster, and obtaining a data-driven fitting function of the control model according to historical control signals of the flexible loads; and
constructing a centralized rapid aggregation control model of the flexible loads based on the data-driven fitting function, formulating a flexible load control solution using the centralized rapid aggregation control model, and obtaining an optimal aggregation control strategy of the flexible loads via the flexible load control solution.

13. (canceled)

14. The device of claim 11, wherein the processor is further configured to:
obtain the flexible load feature vector by splicing the features of the flexible loads via a normalization method; and
obtain a hierarchical clustering result of the massive flexible loads by performing the hierarchical clustering on the massive flexible loads via a predefined clustering method based on the flexible load feature vector and a similarity rule, wherein the hierarchical clustering result comprises different flexible load clusters.

15. The device of claim 11, wherein the processor is further configured to:
obtain a flexible load operation model, and obtain a control variable, an environment variable, response power consumption, and an auxiliary variable of the flexible load cluster from the flexible load operation model;
obtain the flexible load control model based on a relationship among the control variable, the environment variable, the response power consumption, and the auxiliary variable; and
construct a standardized closed-form solution of the flexible load control model based on the control variable and the flexible load operation model.

16. The device of claim 11, wherein the processor is further configured to:
generate a historical control signal dataset of the flexible loads using a Monte Carlo sampling method;
determine whether control signals in the historical control signal dataset falls within critical regions, count a number of control signals in each critical region according to the determined result, and obtain probability densities that the critical regions being called;
compare the probability densities that the critical regions being called with a density boundary threshold, and obtain a critical region optimization result by optimizing the critical regions according to the comparison result, wherein the critical region optimization result comprises retained critical regions and new generated critical regions; and
obtain a data-driven fitting control model by merging the retained critical regions with the new generated critical regions.

17. The device of claim 16, wherein the processor is further configured to:
obtain a mixed-integer linear constraint equation according to the data-driven fitting control model, and construct the centralized rapid aggregation control model based on constraint equation expression;
obtain an optimal solution of a flexible load control signal by solving the centralized rapid aggregation control model using a predefined optimization algorithm; and
obtain an optimal control signal based on the optimal solution of the flexible load control signal, and obtain corresponding optimal power consumption based on the optimal control signal and the flexible load cluster.

18. The storage medium of claim 12, wherein obtaining the flexible load feature vector according to the features of the flexible loads, and obtaining the flexible load cluster by performing the hierarchical clustering on the flexible loads based on the flexible load feature vector, comprising:
obtaining the flexible load feature vector by splicing the features of the flexible loads via a normalization method; and
obtaining a hierarchical clustering result of the massive flexible loads by performing the hierarchical clustering on the massive flexible loads via a predefined clustering method based on the flexible load feature vector and a similarity rule, wherein the hierarchical clustering result comprises different flexible load clusters.

19. The storage medium of claim 12, wherein constructing the flexible load control model based on the flexible load cluster comprises:
obtaining a flexible load operation model, and obtaining a control variable, an environment variable, response power consumption, and an auxiliary variable of the flexible load cluster from the flexible load operation model;
obtaining the flexible load control model based on a relationship among the control variable, the environment variable, the response power consumption, and the auxiliary variable; and
constructing a standardized closed-form solution of the flexible load control model based on the control variable and the flexible load operation model.

20. The storage medium of claim 12, wherein obtaining the data-driven fitting function of the control model according to the historical control signals of the flexible loads comprises:
generating a historical control signal dataset of the flexible loads using a Monte Carlo sampling method;
determining whether control signals in the historical control signal dataset falls within critical regions, counting a number of control signals in each critical region according to the determined result, and obtaining probability densities that the critical regions being called;
comparing the probability densities that the critical regions being called with a density boundary threshold, and obtaining a critical region optimization result by optimizing the critical regions according to the comparison result, wherein the critical region optimization result comprises retained critical regions and new generated critical regions; and
obtaining a data-driven fitting control model by merging the retained critical regions with the new generated critical regions.

21. The storage medium of claim 20, wherein formulating the flexible load control solution using the centralized rapid aggregation control model, and obtaining the optimal aggregation control strategy of the flexible loads via the flexible load control solution comprises:
obtaining a mixed-integer linear constraint equation according to the data-driven fitting control model, and constructing the centralized rapid aggregation control model based on constraint equation expression;
obtaining an optimal solution of a flexible load control signal by solving the centralized rapid aggregation control model using a predefined optimization algorithm; and
obtaining an optimal control signal based on the optimal solution of the flexible load control signal, and obtaining corresponding optimal power consumption based on the optimal control signal and the flexible load cluster.
